(19) United States
(12) Patent Application Publication
(10) Pub. No.: US 2009/0160542 A1
(43) Pub. Date: Jun. 25, 2009

(54) STABLE VOLTAGE GENERATING CIRCUIT FOR A DELAY LOCKED LOOP AND SEMICONDUCTOR MEMORY DEVICE INCLUDING THE SAME AND METHOD OF GENERATING A STABLE VOLTAGE FOR A DELAY LOCKED LOOP

(76) Inventor: Byung Deuk Jeon, Chungcheongbuk-do (KR)

Correspondence Address: LADAS & PARRY LLP, 224 SOUTH MICHIGAN AVENUE, SUITE 1600, CHICAGO, IL, 60604, US

(21) Appl. No.: 12/166,412

(22) Filed: Jul. 2, 2008

(30) Foreign Application Priority Data
Dec. 21, 2007 (KR) 10-2007-0135573

(51) Int. Cl. G05F 1/10

(52) U.S. Cl. 327/546; 327/545

(57) ABSTRACT

A stable voltage generating circuit for a delay locked loop for generating a stable internal voltage for a delay locked loop and a semiconductor memory device including the same, and a method of generating a stable voltage for a delay locked loop is disclosed. The voltage generating circuit includes a first detector which compares a feedback voltage that represents the internal voltage for the delay locked loop with a reference voltage and outputs the comparison result as a first detection signal. A second detector detects the escape timing of a power down mode to provide a second detection signal having a configurable enable width interval after the escape timing of the power down mode. Finally, the voltage generating circuit includes a voltage driver which drives and outputs the internal voltage either the first detection signal or the second detection signal is enabled to maintain a stable internal voltage level.

### CROSS-REFERENCE TO RELATED APPLICATIONS

The present application claims priority to Korean patent application number 10-2007-0135573 filed on Dec. 21, 2007, which is incorporated herein by reference in its entirety.

### BACKGROUND OF THE INVENTION

The present invention relates to a semiconductor memory device, and more particularly to a voltage generating circuit for a delay locked loop generating an internal voltage for a delay locked loop and a semiconductor memory device including the same, and a method of generating voltage for a delay locked loop.

In general, a synchronous semiconductor memory device is synchronized with a clock signal to input/output data. Such a synchronous semiconductor memory device includes an internal clock generating circuit which generates an internal clock signal synchronized with the clock signal.

The internal clock generating circuit may be implemented in various ways. In particular, a delay locked loop (DLL) can be used as the internal clock generating circuit, which can accurately control a delay amount of the internal clock signal.

The delay locked loop should be supplied with stable power for an accurate delaying and locking operation. Therefore, a conventional semiconductor memory device is provided with a separate voltage generation circuit which generates the internal voltage for the delay locked loop. The voltage generation circuit will be described with reference to FIG. 1.

As shown in FIG. 1, a conventional semiconductor memory device includes a voltage generating circuit 10 which generates an internal voltage VDLL for a delay locked loop and a delay locked loop 12 received the internal voltage VDLL as an operating voltage. The delay locked loop 12 delays and locks a clock signal CLK to output it as an internal clock signal DLLCLK.

More specifically, the voltage generating circuit 10 generates the internal voltage VDLL and compares a reference voltage VREFI with the internal voltage VDLL to constantly maintain the internal voltage VDLL level.

In other words, the reference voltage VREFI supplied from a reference voltage generator (not shown) inputted to the voltage generating circuit 10, comprises half of the targeted internal voltage VDLL level. A node ND1 is maintained at half of the internal voltage VDLL level by the distribution of NMOS transistors N1, N2.

When the potential of the node ND1 is lower than the internal voltage VDDL level due to a decrease in the internal voltage VDLL level, a node ND2 becomes a low level by operation of an operational amplifier AMP1. When the node ND2 is a low level, the PMOS transistor P1 is turned on to raise the internal voltage VDLL level.

When the internal voltage VDLL level rises above a specific value, the potential of the node ND1 is higher than the internal voltage VDLL level such that the node ND2 becomes a high level by operation of the operational amplifier AMP1. Accordingly, the PMOS transistor P1 is turned-off to decrease the internal voltage VDLL level.

According to such a method, the voltage generating circuit 10 supplies and maintains the targeted internal voltage VDLL required for the delay locked loop 12. The delay locked loop 12 is turned on by receiving the internal voltage VDLL to perform the delay and lock on the clock signal CLK.

However, in a conventional semiconductor memory device including such a voltage generating circuit 10, it may occur where the internal voltage VDDL level suddenly decreases in special situations.

For example, as shown in FIG. 2, a clock enable signal CKE falls to a low level at the beginning of a power down mode PDEN to minimize power consumption.

An escape from a power down mode PDEX is made where the clock enable signal CKE rises to a high level after lapse of a predetermined time. A phenomenon where the internal voltage VDLL for the delay locked loop decreases more than the targeted level occurs during the escape of the power down mode PDEX.

In other words, a phenomenon where the used internal voltage VDDL level temporarily decreases, such as the dotted circle portion 20 indicated in FIG. 2, occurs since the delay locked loop is not operated after entry of the power down mode PDEN, but the delay locked loop is suddenly operated during the escape of the power down mode PDEX.

In particular, when a read operation is performed immediately after the escape of the power down mode PDEX, the internal voltage VDLL level is suddenly degraded so that the internal clock DLLCLK outputted may be delayed more than normal since the delay locked loop is turned on immediately after the escape of the power down mode PEDX.

In this case, a data path operating in synchronization with the internal clock DLLCLK is delayed so that data may be outputted later than normal, thereby causing a problem where it cannot satisfy ‘tAC’, that is the data output access time.

### SUMMARY OF THE INVENTION

The present invention provides a voltage generating circuit for a delay locked loop capable of preventing instability in an internal voltage level for the delay locked loop due to a sudden operation of the delay locked loop.

The present invention provides a semiconductor memory device capable of preventing instability in an internal voltage level for the delay locked loop due to a sudden operation of the delay locked loop.

The present invention provides a voltage generating method for a delay locked loop capable of preventing instability in an internal voltage level for the delay locked loop due to a sudden operation of the delay locked loop.

There is provided a voltage generating circuit for a delay locked loop according to one embodiment of the present invention, comprising: a first detector comparing a feedback voltage representing an internal voltage for the delay locked loop with a reference voltage and outputting the comparison result as a first detection signal; a second detector detecting an the escape timing of a power down mode and providing a second detection signal having an enable interval of predetermined width after the escape timing of the power down mode; and a voltage driver driving and outputting the internal voltage when at least one of the first detection signal and the second detection signal is enabled.

In the configuration, preferably, the second detector detects the escape timing of the power down mode as a clock enable signal, and in particular, preferably, the second detector provide the second detection signal to enable corresponding to an enable timing of the delay locked loop after the escape timing of the power down mode in response to the clock enable signal.

Preferably, the second detector comprises a first delay unit which delaying the clock enable signal from the escape timing of the power down mode to a first timing where the delay locked loop is enabled; a second delay unit delaying an output of the first delay unit until a second timing; and a logic arithmetic unit logically combining the output of the first delay unit and an output of the second delay unit and outputting the second detection signal enabled at the first timing, and wherein the enable interval width of the second detection signal is the interval between the first timing and the second timing.

Preferably, at least one of the first and second delay units controls a delay amount by an external control. In particular, preferably, at least one of the first and second delay units controls the delay amount according to a fuse cutting or a test signal state.

Preferably, the voltage driver comprises a combination unit performing a logical NOR operation on the first detection signal and the second detection signal; and a driver selectively driving and outputting the internal voltage according to an output state of the combination unit.

In the configuration, preferably, the driver comprises a switching device selectively supplying a power supply voltage to an output terminal outputting the internal voltage according to the output state of the combination unit; and a voltage divider dividing the internal voltage to provide the divided internal voltage as the feedback voltage.

Preferably, the switching device comprises a MOS transistor having a gate supplied with an output of the combination unit to transfer the power supply voltage to the output terminal.

Preferably, the voltage divider comprises MOS transistor-type diodes serially connected between the output terminal and a ground voltage terminal.

There is provided a semiconductor memory device according to another embodiment of the present invention, comprising: a voltage generating circuit generating an internal voltage for a delay locked loop, comparing a currently outputted internal voltage with a reference voltage to maintain the internal voltage level, and independently maintaining the internal voltage level with respect to the comparison during a predetermined interval after an escape timing of a power down mode; and a delay locked loop which receiving the interval voltage to perform a delay and lock on a clock signal.

In the configuration, preferably, the voltage generating circuit drives the internal voltage during the predetermined interval after the escape timing of the power down mode to compensate for a decrease in the internal voltage level according to the delay locked loop being enabled.

Preferably, the voltage generating circuit comprises a detection circuit comparing a feedback voltage representing the internal voltage with the reference voltage, detecting the escape timing of the power down mode, and combining the comparison result and the detection result to output it as a driving signal; and a driver driving the internal voltage in response to the driving signal to maintain the internal voltage level.

Preferably, the detection circuit comprises a first detector comparing the feedback voltage representing the internal voltage with the reference voltage and outputting the comparison result as a first detection signal; a second detector detecting the escape timing of the power down mode and providing a second detection signal having an enable interval of a predetermined width after the escape timing of the power down mode; and a combination unit combining the first detection signal and the second detection signal and enabling and outputting the driving signal when at least one of the first detection signal and the second detection signal is enabled.

In the configuration, preferably, the second detector detects the escape timing of the power down mode as a clock enable signal state, and in particular, preferably, the second detector provide the second detection signal to enable corresponding to an enable timing of the delay locked loop after the escape timing of the power down mode in response to the clock enable signal.

Preferably, the second detector comprises a first delay unit delaying the clock enable signal from the escape timing of the power down mode to a first timing where the delay locked loop is enabled; a second delay unit delaying an output of the first delay unit until a second timing; and a logic arithmetic unit logically combining the output of the first delay unit and an output of the second delay unit and outputting the second detection signal enabled at the first timing, and wherein the enable interval width of the second detection signal is the interval between the first timing and the second timing.

Preferably, at least one of the first and second delay units controls a delay amount by an external control. In particular, preferably, at least one of the first and second delay units controls the delay amount according to a fuse cutting or a test signal state.

Preferably, the combination unit comprises a NOR gate performing a logical NOR operation on the first detection signal and the second detection signal and outputting it as the driving signal.

Preferably, the voltage driver comprises a switching device selectively supplying a power supply voltage to an output terminal outputting the internal voltage according to the driving signal state; and a voltage divider dividing the internal voltage to provide the divided internal voltage as the feedback voltage.

Preferably, the switching device comprises a MOS transistor having a gate supplied with the driving signal to transfer the power supply voltage to the output terminal.

Preferably, the voltage divider comprises MOS transistor-type diodes serially connected between the output terminal and a ground voltage terminal.

There is provided a semiconductor memory device according to another embodiment of the present invention, comprising: a voltage generating circuit generating an internal voltage for a delay locked loop, comparing a currently outputted internal voltage with a reference voltage to maintain the internal voltage level, and independently maintaining the internal voltage level with respect to the comparison during a predetermined interval according to a clock enable signal state; and a delay locked loop receiving the interval voltage to perform a delay and lock on a clock signal.

In the configuration, preferably, the voltage generating circuit drives the internal voltage during the predetermined interval after a rising edge timing of the clock enable signal to compensate for a decrease in the internal voltage level according to the delay locked loop being enabled.

Preferably, the voltage generating circuit comprises a first detector comparing a feedback voltage representing the internal voltage with the reference voltage and outputting the comparison result as a first detection signal; a second detector detecting the clock enable signal and providing a second detection signal having an enable interval of a predetermined width after the rising edge timing of the clock enable signal; and a voltage driver driving and outputting the internal voltage when at least one of the first detection signal and the second detection signal is enabled.

Preferably, the second detector comprises a first delay unit delaying the clock enable signal until a the first timing where the delay locked loop is enabled; a second delay unit delaying the output of the first delay unit until the second timing; and a logic arithmetic unit logically combining the output of the first delay unit and an output of the second delay unit and outputting the second detection signal enabled at the first timing, and wherein the enable interval width of the second detection signal is the interval between the first timing and the second timing.

Preferably the voltage driver comprises a combination unit performing a logical NOR operation on the first detection signal and the second detection signal; and a driver selectively driving and outputting the internal voltage according to an output state of the combination unit.

There is provided a voltage generating method for a delay locked loop according to another embodiment of the present invention, comprising: a first detecting step comparing feedback voltage representing an internal voltage for the delay locked loop with a reference voltage and outputting the comparison result as a first detection signal; a second detecting step detecting an escape timing of a power down mode and providing a second detection signal having an enable interval of a predetermined width after the escape timing of the power down mode; and a voltage generating step generating the internal voltage and providing the generated internal voltage to the delay locked loop and driving the internal voltage when at least one of the first detection signal and the second detection signal is enabled.

In the method, preferably, the step of detecting the escape timing judges the escape timing of the power down mode as a clock enable signal state, and in particular, preferably, the step of detecting the escape timing uses the clock enable signal to enable and provide the second detection signal having an enable interval of a predetermined width from an enable timing of the delay locked loop after the escape timing of the power down mode.

Preferably, the step of detecting the escape timing comprises delaying the clock enable signal from the escape timing of the power down mode until a first timing where the delay locked loop is enabled; delaying the delayed lock enable signal until a the second timing; and logically combining the clock enable signal delayed until the first timing and the clock enable signal delayed until the second timing to output the second detection signal having the enable interval width as an interval between the first timing and the second timing.

### BRIEF DESCRIPTION OF THE DRAWINGS

FIG. 1 is a diagram showing a conventional semiconductor memory device including an internal voltage generating circuit for a delay locked loop.

FIG. 2 is a waveform diagram for explaining a level falling phenomenon of the internal voltage for the delay locked loop according to an escape of a power down mode in the conventional semiconductor memory device.

FIG. 3 is a diagram showing a semiconductor memory device including an internal voltage generating circuit for a delay locked loop according to an embodiment of the present invention.

FIG. 4 is a waveform diagram for explaining a level stabilization operation of the internal voltage for the delay locked loop after an escape of a power down mode in the semiconductor memory device according to an embodiment of the present invention.

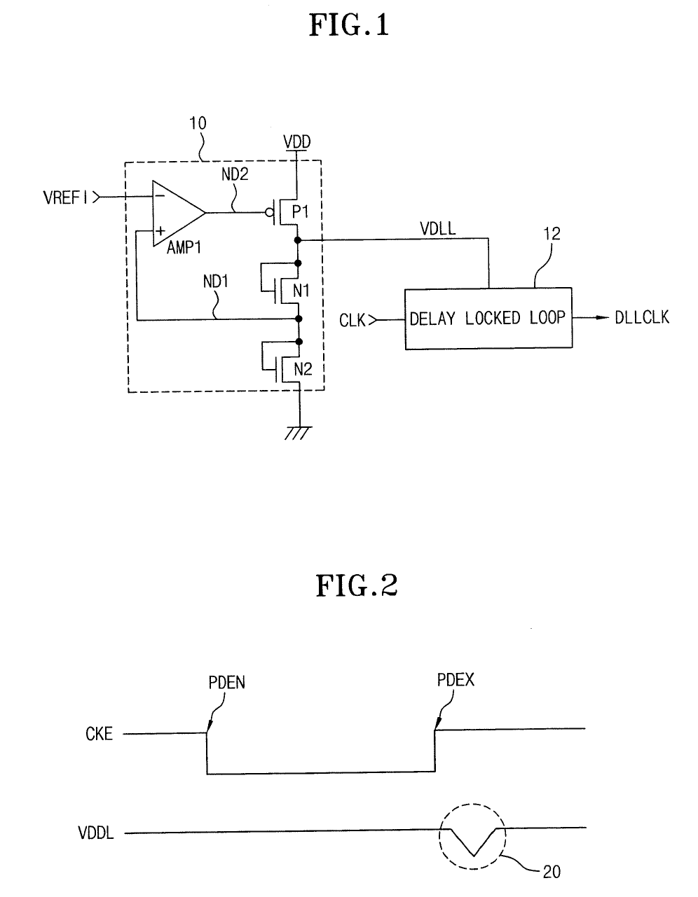

### DESCRIPTION OF SPECIFIC EMBODIMENTS

Hereinafter, preferred embodiments of the present invention will be described in detail with reference to the accompanying drawings.

The present invention provides a voltage generating circuit for a delay locked loop capable of maintaining a stable internal voltage by compensating for a decrease in level of the internal voltage through driving of the internal voltage for the delay locked loop when the delay locked loop is suddenly operated, a semiconductor memory device including the same, and a voltage generating method for the delay locked loop. In particular, the present invention can prevent an output delay phenomenon of the delay locked loop due to the decrease of the internal voltage level when a read operation is performed immediately after an escape of a power down mode.

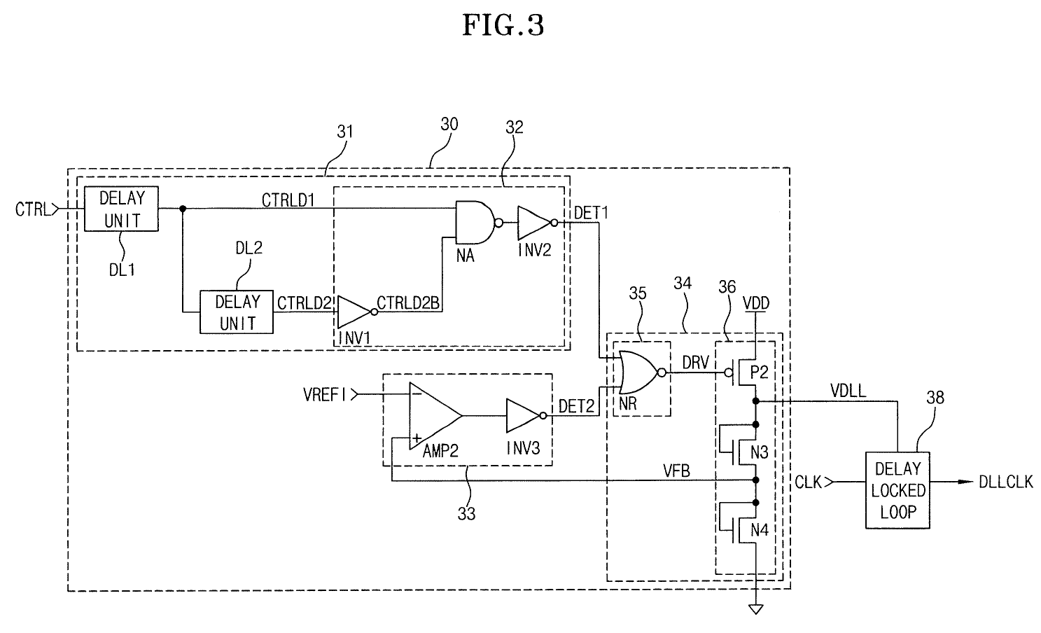

More specifically, referring to FIG. 3, the semiconductor memory device according to an embodiment of the present invention includes a voltage generating circuit 30 and a delay locked loop 38.

The voltage generating circuit 30 generates the internal voltage VDLL for the delay locked loop, compares the currently outputted internal voltage VDLL with a reference voltage VREFI to maintain the internal voltage VDLL level, and independently maintains the internal voltage VDLL level with respect to the comparison during a predetermined interval according to a control signal CTRL state.

Herein, a clock enable signal CKE may be representatively used as the control signal CTRL, which is a signal capable of describing the operational state of the delay locked loop 38. In other words, the operational state of the delay locked loop 38 can be understood via the clock enable signal CKE since the delay locked loop 38 transitions from a turn on state to a turn off state where the clock enable signal CKE transitions from a high level to a low level and the delay locked loop 38 transitions from the turn off state to the turn on state where the clock enable signal CKE transitions from the low level to the high level.

The control signal CTRL may also be a signal having a state corresponding to the entry or escape of the specific operating mode. Herein, the specific operating mode may representatively correspond to the power down mode. In other words, the control signal CTRL having a state corresponding to the entry or escape of the power down mode may be inputted to the voltage generating circuit 30 since the delay locked loop 38 is turned off at the entry of the power down mode and the delay locked loop 38 is turned on during the escape of the power down mode.

In particular, when the control signal CTRL has a state corresponding to the entry and escape of the power down mode, the clock enable signal CKE may be used as the control signal CTRL. For reference, the clock enable signal CKE transitions from a high level to low level corresponding to the entry of the power down mode or a self refresh mode and transitions from a low level to high level corresponding to the escape of the power down mode or the self refresh mode.

The voltage generating circuit 30, which drives the internal voltage VDLL by receiving the control signal CTRL and the reference voltage VREFI, may include two detectors 31, 33 and a voltage driver 34.

The detector 31 uses the control signal CTRL to detect the operational state of the delay locked loop 38, thereby providing the detected result as a detection signal DET1. Preferably, the detector 31 detects the escape timing in the specific mode where the delay locked loop 38 is in a turned off state as in the power down mode by the control signal CTRL, so that the detection signal DET1 having a predetermined width of an enable interval where the delay locked loop 38 is turned on after the escape of the specific mode is provided.

To this end, the detector 31 may include two delay units DL1, DL2 and a logic arithmetic unit 32.

The delay unit DL1 delays the control signal CTRL to output it as a delay control signal CTRLD1. Preferably, it delays the control signal CTRL from the escape timing of the specific mode (for example, the power down mode) to the turn on timing of the delay locked loop 38 to output it as the delay control signal CTRLD1.

Herein, the delay unit DL1 may vary a delay amount by external control, and in particular, may vary the delay amount according to a fuse cutting or a test signal state. For example, the delay unit DL1 is configured of a plurality of unit delay cells (not shown), wherein the unit delay cells are selectively connected to a delay path of the control signal CTRL by the fuse or the test signal so that the configuration controlling the delay amount may be controlled.

The delay unit DL2 delays the delay control signal CTRLD1 to output it as the delay control signal CTRLD2, which is used for determining the enable width of the detection signal DET1.

Herein, the delay unit DL2 may vary the delay amount by external control using the same method as the delay unit DL1.

The logic arithmetic unit 32 logically operates the delay control signal CTRLD1 and the delay control signal CTRLD2 to output it as the detection signal DET1. At this time, the detection signal DET1 is enabled at the timing where the delay locked loop 38 is turned on after the escape of the specific mode (for example, the power down mode) and may have the enable interval corresponding to the delay amount of the delay unit DL2.

The logic arithmetic unit 32 may include an inverter INV1 which inverts the delay control signal CTRLD2 to output it as an inverted delay control signal CTRLD2B, a NAND gate NA which logically NANDs the delay control signal CTRLD1 and the inverted delay control signal CTRLD2B, and an inverter INV2 which inverts the output of the NAND gate NA to output it as the detection signal DET1.

Meanwhile, the detector 33 compares feedback voltage VFB representing the internal voltage VDLL with the reference voltage VREFI to output the comparison result as a detection signal DET2. Preferably, the reference voltage VREFI has a level equal to or less than the internal voltage VDLL. For example, the reference voltage VREFI may be half the internal voltage VDLL level. Preferably, the reference voltage VREFI is a voltage generated from a general bandgap reference voltage generating circuit (not shown).

The detector 33 may include an operational amplifier AMP2, which compares the reference voltage VREFI level with the feedback voltage VFB level to output the comparison result as a signal with a predetermined logic level, and an inverter INV3, which inverts the output of the operational amplifier AMP2 to output it as the detection signal DET2. Preferably, the operational amplifier AMP2 outputs a low level signal when the reference voltage VREFI is higher than the feedback voltage VFB and outputs a high level signal when the reference voltage VREFI is lower than the feedback voltage VFB.

The voltage driver 34 drives and outputs the internal voltage VDLL when at least one of either the detection signal DET1 outputted from the detector 31 or the detection signal DET2 outputted from the detector 33 is enabled, and may include a combination unit 35 and a driver 36.

The combination unit 35 performs a NOR operation on the detection signal DET1 and the detection signal DET2 to output it as the driving signal DRV. The combination unit 35 preferably, includes a NOR gate NR.

The driver 36 drives and outputs the internal voltage VDLL according to the driving signal DRV and preferably, includes a switching device and a voltage divider.

Herein, the switching device selectively supplies a power supply voltage VDD to an output terminal outputting the internal voltage VDLL according to the driving signal DRV state and preferably, includes a MOS transistor having a gate supplied with the driving signal DRV to transfer the power supply voltage VDD to the output terminal. Preferably, the MOS transistor is a PMOS transistor P2.

The voltage divider divides the internal voltage VDLL to provide it as the feedback voltage VFB and preferably, includes two or more MOS transistor-type diodes serially connected between the output terminal and a ground voltage VSS terminal. Preferably, the MOS transistor-type diodes are NMOS transistor-type diodes N3, N4. When the reference voltage VREFI is half of the targeted internal voltage VDLL, the NMOS transistor-type diodes N3, N4 divide the current internal voltage VDLL level by half to output it as the feedback voltage VFB.

The delay locked loop 38 receives the internal voltage VDLL as the driving voltage and delays and locks the clock signal CLK to output it as an internal clock signal DLLCLK for determining the output timing of data.

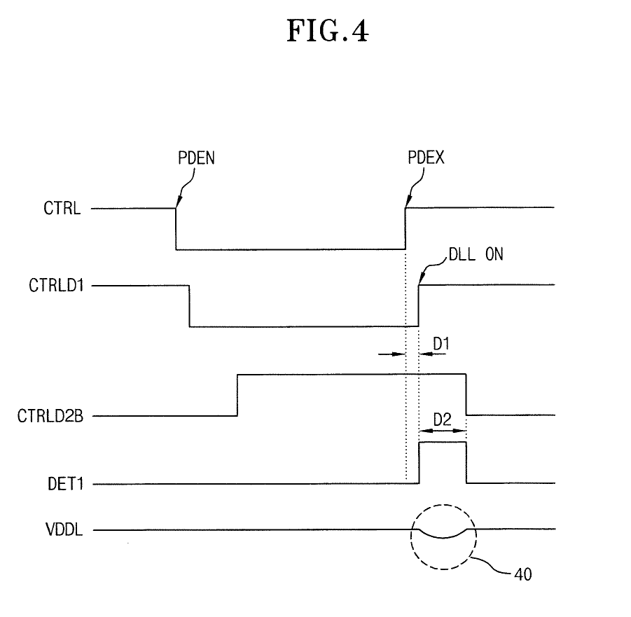

An operation of the semiconductor memory device having the configuration as above will be described in detail with reference to FIGS. 3 and 4.

First, during a normal operational mode of the semiconductor memory device, the internal voltage VDLL for the delay locked loop 38 having the predetermined level is generated by the reference voltage VREFI and the power supply voltage VDD. The internal voltage VDLL is divided by the two NMOS transistor-type diodes N3, N4 to generate the feedback voltage VFB.

The feedback voltage VFB is compared with the reference voltage VREFI through the operational amplifier AMP2 and the comparison result is outputted as the detection signal DET2 via the inverter INV3.

When the feedback voltage VFB level is lower than the reference voltage VREFI level, that is, the internal voltage VDLL level is lower than the target level, the detection signal DET2 has a high level. The detection signal DET2 having the high level is outputted as the driving signal DRV of a low level via the NOR gate NR. When the driving signal DRV is a low level, the PMOS transistor P2 is driven, that is, turned-on so that the internal voltage VDLL level rises.

Thereafter, when the internal voltage VDLL level rises above the specific value, the feedback voltage VFB is higher than the reference voltage VREFI so that the detection signal DET2 has a low level. When the control signal CTRL is disabled, the detection signal DET1 is maintained at a low level so that the driving signal DRV having the high level is outputted via a combination of the two detection signals DET1, DET2. Accordingly, the PMOS transistor P2 is turned-off so that the internal voltage VDLL level decreases.

The internal voltage VDLL may be maintained at the targeted level in the normal mode through the level comparison of the feedback voltage VFB, representing the internal voltage VDLL, and the reference voltage VREFI.

Next, when the semiconductor memory device operates in a specific mode, such as in the power down mode, the control signal CTRL is enabled and the delay unit DL1 delays the control signal until the turn on timing (DLL ON) of the delay locked loop 38, that is, as much delay ‘D1’ needed based on the predetermined edge of the control signal CTRL.

For example, assume that the control signal CTRL is the clock enable signal CKE. The clock enable signal CKE is shifted from a high level to a low level corresponding to the entry of the power down mode PDEN. The clock enable signal CKE is shifted from a low level to a high level corresponding to the escape of the power down mode PDEX.

In this case, the delay unit DL1 receives the clock enable signal CKE in order to delay it until the turn on timing (DLL ON) of the delay locked loop 38 based on the escape timing of the power down mode PDEX, that is, the rising edge of the control enable signal CKE.

The delay control signal CTRLD1 is delayed by ‘D1’ via the delay unit DL1 and is inputted to the delay unit DL2 so that it is delayed by ‘D2’ and further outputted as an inverted delay control signal CTRLD2B via the inverter INV1. The delay amount ‘D2’ of the delay unit DL2 determines a pulse width of the detection signal DET1 to be described later.

The delay control signal CTRLD1 generated via the delay unit DL1, and the inverted delay control signal CTRLD2B generated via the delay unit DL2 and the inverter INV1, are logically combined through the NAND gate NA and the inverter INV2 to output the detection signal DET1. Preferably, the detection signal DET1 is a pulse signal having an enable interval as much as ‘D2’ from the turn on timing DLL ON of the delay locked loop 38.

When the detection signal DET1 is enabled at a high level according to the turn on timing (DLL ON) of the delay locked timing, the driving signal DRV is a low level regardless of the detection signal DET2 state so that the PMOS transistor P2 is driven, that is, turned on to supply the power supply voltage VDD to the output terminal (a node outputting the internal voltage VDLL). Thereafter, the detection signal DET1 falls to a low level after ‘D2’ and the voltage generating circuit 30 reverts back to normal mode operation.

In other words, when the delay locked loop 38 is turned on immediately after the escape of the power down mode PDEX, for example, when a read operation is performed immediately after the escape of the power down mode PDEX, the detection signal DET1 is enabled for ‘D2’ from the turn on timing (DLL ON) of the delay locked loop 38 and the power supply voltage VDD is supplied to the output terminal during the enable interval of the detection signal DET1. Accordingly, even when the delay locked loop 38 is suddenly operated, the internal voltage does not suddenly fall as in the dotted circle 40 of FIG. 4, but can be approximately maintained at a targeted level.

The delay amount ‘D1’ for determining the enable timing of the detection signal DET1 and the delay amount ‘D2’ for determining the enable width of the detection signal DET1 is carefully configured through the simulation.

When the delay amount ‘D1’ is too small, the enable timing of the detection signal DET1 occurs too early so that unnecessary current may be consumed. When the delay amount ‘D1’ is too large, the detection signal DET1 is enabled after the delay locked loop 38 is turned on and the internal voltage VDLL level cannot be rapidly stabilized.

Also, when the delay amount ‘D2’ is too small, the enable interval of the detection signal DET1 is too short to sufficiently supply the power supply voltage VDD to the output terminal. Accordingly, the internal voltage VDLL level cannot be rapidly stabilized. On the other hand, when the delay amount ‘D2’ is too large, the enable interval of the detection signal DET1 is too long so that the internal voltage VDLL level may be higher than the targeted level.

The delay amount ‘D1’, ‘D2’ determine the enable timing and enable interval of the detection signal DET1 and may be varied through the delay units DL1, DL2. In particular, when a fuse or test signal is used, the delay amount ‘D1’, ‘D2’ can be controlled without a separate circuit revision after a memory chip is completed.

As described above, the semiconductor memory device according to an embodiment of the present invention has the configuration which drives the internal voltage VDLL for a predetermined time, that is, supplies the power supply voltage VDD to the output terminal outputting the internal voltage VDLL, when the delay locked loop is not operating in a specific mode but rather when the delay locked loop is suddenly operated in the escape of the specific mode.

In particular, when a read operation is performed immediately after the escape of a power down mode, the internal voltage VDLL level may suddenly be degraded since the delay locked loop is turned on immediately after the escape of the power down mode.

However, the semiconductor memory device according to an embodiment of the present invention supplies the power supply voltage VDD to the output terminal outputting the internal voltage VDLL at the timing where the delay locked loop is turned on after the escape of the power down mode, making it possible to compensate for the sudden degradation of the internal voltage VDLL level.

Since the internal voltage VDLL can be maintained at a stable level after an operation causing the internal voltage VDLL level for the delay locked loop to become unstable, in particular, even after the escape of the power down mode, the delay locked loop operates normally to prevent the delay phenomenon of data so that the ‘tAC’ can be improved.

The present invention provides a voltage generating circuit for the delay locked loop which drives the internal voltage for the delay locked loop to compensate for the decrease of the internal voltage level when the delay locked loop is suddenly operated, making it possible to maintain a stable internal voltage level.

The present invention provides a semiconductor memory device which drives the internal voltage for the delay locked loop to compensate for the decrease of the internal voltage level when the delay locked loop is suddenly operated, making it possible to maintain a stable internal voltage level.

The present invention provides a voltage generating method for the delay locked loop which drives the internal voltage for the delay locked loop to compensate for the decrease of the internal voltage level when the delay locked loop is suddenly operated, making it possible to maintain a stable internal voltage level.

Those skilled in the art will appreciate that the specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

What is claimed is:

1. A voltage generating circuit for a delay locked loop, comprising:
a first detector comparing a feedback voltage representing an internal voltage for the delay locked loop with a reference voltage and outputting the comparison result as a first detection signal;
a second detector detecting an escape timing of a power down mode and providing a second detection signal having an enable interval of predetermined width after the escape timing of the power down mode; and
a voltage driver driving and outputting the internal voltage when at least one of the first detection signal and the second detection signal is enabled.

2. The voltage generating circuit as set forth in claim 1, wherein the second detector detects the escape timing of the power down mode as a clock enable signal.

3. The voltage generating circuit as set forth in claim 2, wherein the second detector provide the second detection signal to enable corresponding to an enable timing of the delay locked loop after the escape timing of the power down mode in response to the clock enable signal.

4. The voltage generating circuit as set forth in claim 2, wherein the second detector comprises:
a first delay unit delaying the clock enable signal from the escape timing of the power down mode to a first timing where the delay locked loop is enabled;
a second delay unit delaying an output of the first delay unit until a second timing; and
a logic arithmetic unit logically combining the output of the first delay unit and an output of the second delay unit and outputting the second detection signal enabled at the first timing, and
wherein the enable interval width of the second detection signal is the interval between the first timing and the second timing.

5. The voltage generating circuit as set forth in claim 4, wherein at least one of the first and second delay units controls a delay amount by an external control.

6. The voltage generating circuit as set forth in claim 5, wherein at least one of the first and second delay units controls the delay amount according to a fuse cutting or a test signal state.

7. The voltage generating circuit as set forth in claim 1, wherein the voltage driver comprises:
a combination unit performing a logical NOR operation on the first detection signal and the second detection signal; and
a driver selectively driving and outputting the internal voltage according to an output state of the combination unit.

8. The voltage generating circuit as set forth in claim 7, wherein the driver comprises:
a switching device selectively supplying a power supply voltage to an output terminal outputting the internal voltage according to the output state of the combination unit; and
a voltage divider dividing the internal voltage to provide the divided internal voltage as the feedback voltage.

9. The voltage generating circuit as set forth in claim 8, wherein the switching device comprises a MOS transistor having a gate supplied with an output of the combination unit to transfer the power supply voltage to the output terminal.

10. The voltage generating circuit as set forth in claim 8, wherein the voltage divider comprises MOS transistor-type diodes serially connected between the output terminal and a ground voltage terminal.

11. A semiconductor memory device, comprising:
a voltage generating circuit generating an internal voltage for a delay locked loop, comparing a currently outputted internal voltage with a reference voltage to maintain the internal voltage level, and independently maintaining the internal voltage level with respect to the comparison during a predetermined interval after an escape timing of a power down mode; and
a delay locked loop receiving the interval voltage to perform a delay and lock on a clock signal.

12. The semiconductor memory device as set forth in claim 11, wherein the voltage generating circuit drives the internal voltage during the predetermined interval after the escape timing of the power down mode to compensate for a decrease in the internal voltage level according to the delay locked loop being enabled.

13. The semiconductor memory device as set forth in claim 11, wherein the voltage generating circuit comprises:
a detection circuit comparing a feedback voltage representing the internal voltage with the reference voltage, detecting the escape timing of the power down mode, and combining the comparison result and the detection result to output it as a driving signal; and
a driver driving the internal voltage in response to the driving signal to maintain the internal voltage level.

14. The semiconductor memory device as set forth in claim 13, wherein the detection circuit comprises:
a first detector comparing the feedback voltage representing the internal voltage with the reference voltage and outputting the comparison result as a first detection signal;
a second detector detecting the escape timing of the power down mode and providing a second detection signal having an enable interval of a predetermined width after the escape timing of the power down mode; and
a combination unit combining the first detection signal and the second detection signal and enabling and outputting the driving signal when at least one of the first detection signal and the second detection signal is enabled.

15. The semiconductor memory device as set forth in claim 14, wherein the second detector detects the escape timing of the power down mode as a clock enable signal.

16. The semiconductor memory device as set forth in claim 15, wherein the second detector provide the second detection signal to enable corresponding to an enable timing of the delay locked loop after the escape timing of the power down mode in response to the clock enable signal.

17. The semiconductor memory device as set forth in claim 15, wherein the second detector comprises:
a first delay unit delaying the clock enable signal from the escape timing of the power down mode to a first timing where the delay locked loop is enabled;
a second delay unit delaying an output of the first delay unit until a second timing; and
a logic arithmetic unit logically combining the output of the first delay unit and an output of the second delay unit and outputting the second detection signal enabled at the first timing, and
wherein the enable interval width of the second detection signal is the interval between the first timing and the second timing.

18. The semiconductor memory device as set forth in claim 17, wherein at least one of the first and second delay units controls a delay amount by an external control.

19. The semiconductor memory device as set forth in claim 18, wherein at least one of the first and second delay units controls the delay amount according to a fuse cutting or a test signal state.

20. The semiconductor memory device as set forth in claim 14, wherein the combination unit comprises a NOR gate performing a logical NOR operation on the first detection signal and the second detection signal and outputting it as the driving signal.

21. The semiconductor memory device as set forth in claim 13, wherein the driver comprises:
a switching device selectively supplying a power supply voltage to an output terminal outputting the internal voltage according to the driving signal state; and
a voltage divider dividing the internal voltage to provide the divided internal voltage as the feedback voltage.

22. The semiconductor memory device as set forth in claim 21, wherein the switching device comprises a MOS transistor having a gate supplied with the driving signal to transfer the power supply voltage to the output terminal.

23. The semiconductor memory device as set forth in claim 21, wherein the voltage divider comprises MOS transistor-type diodes serially connected between the output terminal and a ground voltage terminal.

24. A semiconductor memory device, comprising:
a voltage generating circuit generating an internal voltage for a delay locked loop, comparing a currently outputted internal voltage with a reference voltage to maintain the internal voltage level, and independently maintaining the internal voltage level with respect to the comparison during a predetermined interval according to a clock enable signal state; and
a delay locked loop receiving the interval voltage to perform a delay and lock on a clock signal.

25. The semiconductor memory device as set forth in claim 24, wherein the voltage generating circuit drives the internal voltage during the predetermined interval after a rising edge timing of the clock enable signal to compensate for a decrease in the internal voltage level according to the delay locked loop being enabled.

26. The semiconductor memory device as set forth in claim 25, wherein the voltage generating circuit comprises:
a first detector comparing a feedback voltage representing the internal voltage with the reference voltage and outputting the comparison result as a first detection signal;
a second detector detecting the clock enable signal state and providing a second detection signal having an enable interval of a predetermined width after the rising edge timing of the clock enable signal; and
a voltage driver driving and outputting the internal voltage when at least one of the first detection signal and the second detection signal is enabled.

27. The semiconductor memory device as set forth in claim 26, wherein the second detector comprises:
a first delay unit delaying the clock enable signal until a first timing where the delay locked loop is enabled;
a second delay unit delaying an output of the first delay unit until a second timing; and
a logic arithmetic unit logically combining the output of the first delay unit and an output of the second delay unit and outputting the second detection signal enabled at the first timing, and
wherein the enable interval width of the second detection signal is the interval between the first timing and the second timing.

28. The semiconductor memory device as set forth in claim 26, wherein the voltage driver comprises:
a combination unit performing a logical NOR operation on the first detection signal and the second detection signal; and
a driver selectively driving and outputting the internal voltage according to an output state of the combination unit.

29. A voltage generating method for a delay locked loop, comprising:
comparing a feedback voltage representing an internal voltage for the delay locked loop with a reference voltage and outputting the comparison result as a first detection signal;
detecting an escape timing of a power down mode and providing a second detection signal having an enable interval of a predetermined width after the escape timing of the power down mode; and
generating the internal voltage and providing the generated internal voltage to the delay locked loop and driving the internal voltage when at least one of the first detection signal and the second detection signal is enabled.

30. The voltage generating method as set forth in claim 29, wherein the step of detecting the escape timing judges the escape timing of the power down mode as a clock enable signal state.

31. The voltage generating method as set forth in claim 30, wherein the step of detecting the escape timing uses the clock enable signal to enable and provide the second detection signal having an enable interval of a predetermined width from an enable timing of the delay locked loop after the escape timing of the power down mode.

32. The voltage generating method as set forth in claim 30, wherein step of detecting the escape timing comprises the steps of:
delaying the clock enable signal from the escape timing of the power down mode until a first timing where the delay locked loop is enabled;
delaying the delayed clock enable signal until a second timing; and
logically combining the clock enable signal delayed until the first timing and the clock enable signal delayed until the second timing to output the second detection signal having the enable interval width as an interval between the first timing and the second timing.
